(19) United States
(12) Patent Application Publication
(10) Pub. No.: US 2017/0024490 A1
(43) Pub. Date: Jan. 26, 2017

(54) Alignment of Metadata

(71) Applicant: CXENSE ASA, Oslo (NO)

(72) Inventor: Raymond Lau, Charlestown, MA (US)

(21) Appl. No.: 15/283,880

(22) Filed: Oct. 3, 2016

Related U.S. Application Data
(63) Continuation of application No. 13/116,669, filed on May 26, 2011, now abandoned.

(51) Int. Cl. G06F 17/30; G06F 17/21; G06F 17/24

(52) U.S. Cl. CPC G06F 17/30997; G06F 17/24; G06F 17/212

(57) ABSTRACT

Methods and apparatus, including computer program products, for alignment of metadata. A method includes receiving two or more variations of an underlying piece of content, each piece of content including metadata, using a text alignment technique to correlate the metadata of the two or more variations, and merging multiple sets of the metadata into one multi-track set from the correlation.

### BACKGROUND OF THE INVENTION

The invention generally relates to digital media, and more specifically to alignment of metadata.

Metadata is loosely defined as data about data. Metadata is commonly used to describe three aspects of digital documents and data: definition, structure and administration. By describing the contents and context of data files, the quality of the original data/files is greatly increased. For example, a web page may include metadata specifying what language it's written in, what tools were used to create it, and where to go for more on the subject, enabling web browsers, such as Firefox® or Opera®, to automatically improve the experience of users.

Metadata is particularly useful in video, where information about its contents, such as transcripts of conversations and text descriptions of its scenes, are not directly understandable by a computer, but where efficient search is desirable. As is often the case, different sources of the same video can include different variations of metadata that are not aligned to each other. Further, the same underlying piece of content can have multiple sets of metadata attached to slight variations of the content. For various purposes, such as indexing, presentation, editing support and so forth, it would be useful to combine multiple sets of metadata into a single set of aligned multi-track metadata.

### SUMMARY OF THE INVENTION

The present invention provides methods and apparatus, including computer program products, for alignment of metadata.

In general, in one aspect, the invention features a method including receiving two or more variations of an underlying piece of content, each piece of content including metadata, using a text alignment technique to correlate the metadata of the two or more variations, and merging multiple sets of the metadata into one multi-track set from the correlation.

In another aspect, the invention features an apparatus including a local computing system linked to a network of interconnected computer systems, the local computing system including a processor, a memory and a storage device. The memory includes an operating system and a metadata alignment process, the metadata alignment process including receiving two or more variations of an underlying piece of content, each piece of content including metadata, using a text alignment technique to correlate the metadata of the two or more variations, and merging multiple sets of the metadata into one multi-track set from the correlation.

In another aspect, the invention features a method including receiving variations of an underlying piece of content, each piece of content including metadata, using a text alignment technique to correlate the metadata of a first variation to a third variation, the correlated metadata including timestamps, using the text alignment technique to correlate the metadata of a second variation to the third variation, the correlated metadata including timestamps, and merging the correlated metadata into one multi-track set.

Other features and advantages of the invention are apparent from the following description, and from the claims.

### BRIEF DESCRIPTION OF THE DRAWINGS

The invention will be more fully understood by reference to the detailed description, in conjunction with the following figures, wherein:

FIG. 1 is a block diagram.

FIG. 2 is a flow diagram.

Like reference numbers and designations in the various drawings indicate like elements.

### DETAILED DESCRIPTION

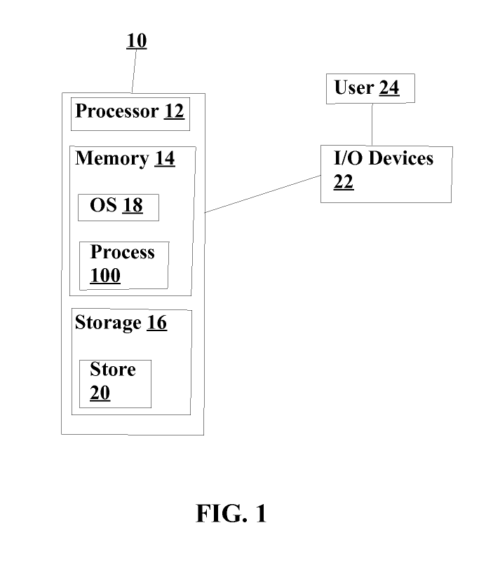

As shown in FIG. 1, an exemplary system 10 includes a processor 12, memory 14 and storage 16. The memory 14 can include an operating system (OS) 18, such as Linux®, Unix®, or Snow Leopard®, and a process 100 for an alignment of metadata. Storage 16 can include a store 20 of content, such as digital audio, digital video, digital text, and so forth. The store 20 can reside in a database. In some implementations, the store of content 20 resides on a server in a network linked to system 10. In other implementations, the store of content 20 resides in the memory 14. System 10 may also include input/output devices 22, such as a keyboard, pointing device and video monitor, for interaction with a user 24.

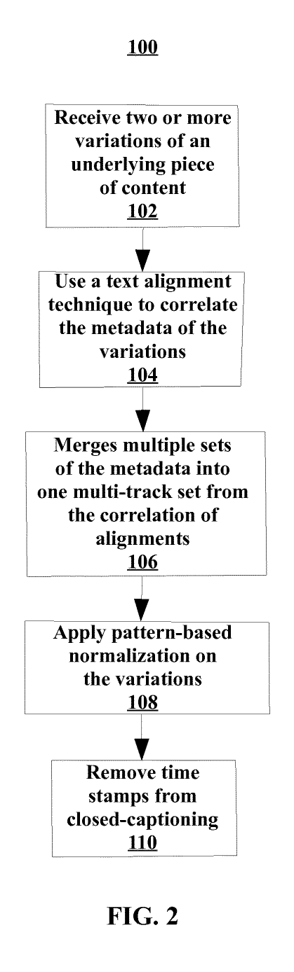

As shown in FIG. 2, the process 100 for alignment of metadata includes receiving (102) two or more variations of an underlying piece of content, each piece of content including metadata. The content may include one or more of digital text, digital audio and digital video. In one specific example, the content can be digital audio and speech-to-text can be performed on the digital audio.

Process 100 uses (104) a text alignment technique to correlate the metadata of the variations. The text alignment technique can be a dynamic process optimizing a metric. The metric can a metric that minimizes a number of word substitutions, insertions and deletions. The metric can be a metric that weights different words differently.

The metric can weigh different errors differently or any other function that can be calculated by comparing two or more sequences of words.

The metric can be calculated in conjunction with natural language processing. The metric can be calculated, in one specific example, using a Viterbi dynamic programming process for finding the most likely sequence of hidden states.

Process 100 merges (106) multiple sets of the metadata into one multi-track set from the correlation of alignments. The one multi-track set can include external non-aligned metadata. The external non-aligned metadata can be selected based on aligned metadata.

Receiving (102) variations of the underlying piece of content can include applying (108) pattern-based normalization on the variations. Applying (108) pattern-based normalization can include removing (110) time stamps from closed-captioning.

In a variation of process 100, instead of text aligning (104) multiple metadata sources directly, process 100 can text align to one or more time-alignments and use the time-alignments to align the metadata sources. For example, speech-to-text can provide a time aligned machine generated transcript. Each metadata source, e.g., the script, closed-captioned file, and so forth, can be text-aligned to the speech-to-text transcript and then have their metadata merged based on occurring at the same time on the timeline.

The same underlying piece of content can have multiple sets of metadata attached to slight variations of the content. For example, a movie may include a script, which includes dividing into scenes with scene metadata like characters, location, time-of-day. The same movie may include a closed caption file that includes descriptors, like “[girl laughing],” for example. Further, the same movie can include a specification of musical accompaniments, which might identify the music played for various scenes in the script. In this example, the words in the script will not match the words in the closed caption file exactly because of errors in the closed-captioning as well as directorial artistic license during the filming process. Similarly, the music specification may use variants of the scene names compared to the script.

The present invention uses text alignment techniques to correlate the variations of the same underlying piece of content and then the correlation to merge the multiple sets of metadata into one multi-track set.

In one implementation, text alignment is performed using a dynamic programming process optimizing a metric. An example metric is the alignment that minimizes the number of word substitutions, insertions and deletions. In one specific example implementation, a Levenshtein distance (LD) can be used. In general, a LD is a measure of the similarity between two strings, which can be referred to as a source string (s) and a target string (t). The distance is the number of deletions, insertions, or substitutions required to transform s into t. For example, ifs is “test” and t is “test”, then LD(s,t)=0, because no transformations are needed. The strings are already identical. Ifs is “test” and t is “tent”, then LD(s,t)=1, because one substitution (change “s” to “n”) is sufficient to transform s into t. The greater the Levenshtein distance, the more different the strings are.

In the present invention, a LD may be employed that, for example, assigns a cost of “3” to insertions, “3” to deletions and “4” to substitutions as another metric.

In other examples, certain words are given more weight in the calculation of the metric (e.g., natural language processing can be used to identify named entities like person names and those might be weighted higher). One specific implementation uses the Viterbi dynamic programming algorithm or variations thereof.

In general, the Viterbi algorithm is a dynamic programming algorithm for finding the most likely sequence of hidden states, referred to as the Viterbi path, which results in a sequence of observed events, especially in the context of Markov information sources, and more generally, hidden Markov models. A forward algorithm is a closely related algorithm for computing the probability of a sequence of observed events. These algorithms belong to the realm of information theory.

The Viterbi algorithm makes a number of assumptions. First, both the observed events and hidden events must be in a sequence. This sequence often corresponds to time. Second, these two sequences need to be aligned, and an instance of an observed event needs to correspond to exactly one instance of a hidden event. Third, computing the most likely hidden sequence up to a certain point t must depend only on the observed event at point t, and the most likely sequence at point t−1. These assumptions are all satisfied in a first-order hidden Markov model.

In other implementations, pattern-based normalizations are performed prior to text alignment. Specifically, with closed-caption files, the time-stamps are typically removed prior to alignment (and made into metadata for later use in the combined multi-track metadata set).

External non-aligned metadata can also be included in the final multi-track metadata set (e.g., a movie's release date). This non-aligned metadata can optionally be selected based on aligned metadata (e.g., the external metadata may be a mapping of characters to actors, the aligned metadata may include the character from the script, and this the techniques of the present invention include the corresponding actor).

In other implementations, speech-to-text is performed on the audio track, with dynamic programming used to time align the closed-caption file. Acoustic forced alignment can be performed against the audio track using the closed-caption as the “truth” transcription. Human-aided transcription can be used in lieu of closed-caption. Speech-to-text can be performed on the audio track and dynamic programming is used to align with any source of text (i.e., not necessarily closed-caption if it isn't available), such as directly to the script.

Techniques of the present invention are not limited to audio/video. A pure text example might be a story along with summary analysis(es) prepared by one or more parties. One goal in this example would be to show the summaries next to the appropriate paragraphs in the story, so the reader can see what various commentators said about each part of the story.

An example of an alignment using the techniques of the present invention involving the first two scenes from the script of “Stripes” is described below.

EXTERIOR/BRIDGE

MOTORISTS: Hey, move that cab, buddy! Hey, you can't stop in the middle of the bridge.

INTERIOR/CLASSROOM

RUSS: Okay, that's really very good. I'd like to try it just one more time. And then we'll call it a day. (sings) ‘I MET HER ON A MONDAY AND MY HEART STOOD STILL.’

CLASS: (sings) ‘DA DOO RUN RUN RUN DA DOO RUN RUN.’

RUSS: (sings) ‘SOMEBODY TOLD ME THAT HER NAME WAS JILL.’

CLASS: (sings) ‘DA DOO RUN RUN RUN DA DOO RUN RUN.’

RUSS: Okay, great. Great. All right, I'll see you next week and we'll learn some new tunes and we'll have a great time. Bye-bye.

CLASS: Bye-bye.

A corresponding excerpt from the caption file for same includes:

0082 01:06:07:12 01:06:09:08

Hey, move your cab, buddy!

0083 01:06:10:00 01:06:11:10

(HORNS HONKING)

0084 01:06:13:13 01:06:16:05

You can't stop on a bridge!

0085 01:06:18:03 01:06:19:12

(CARS CRASHING)

0086 01:06:29:16 01:06:31:09

Ok, that's very good.

Ok, that's very good.

0087 01:06:31:09 01:06:35:16

Let's try it one more time. Then we'll call it a day.

0088 01:06:35:16 01:06:38:28

I met her on a Monday and my heart stood still.

0089 01:06:38:28 01:06:40:10

Da doo ron ron ron.

0090 01:06:40:10 01:06:42:18

Da doo ron ron.

0091 01:06:42:18 01:06:45:08

Somebody told me that her name was Jill.

0092 01:06:45:08 01:06:47:01

Da doo ron ron ron.

0093 01:06:47:01 01:06:48:22

Da doo ron ron.

0094 01:06:48:22 01:06:50:18

Okay, great, great!

0095 01:06:50:18 01:06:52:28

Next week we'll learn some new tunes.

0096 01:06:52:28 01:06:54:03

Bye-bye.

0097 01:06:54:03 01:06:55:13

ALL: Bye-bye!

A corresponding alignment output minimizing substitutions+insertions+deletions follows. The time stamps in the closed-caption file were removed prior to alignment.

CAPS on both lines indicate a substitution

In this example, “****” on line 1 with CAPS on line 2 indicate a deletion on line 1 or conversely an insertion on line 2.

Script: hey move THAT cab buddy ***** HEY you cant stop IN THE MIDDLE OF THE bridge **** RUSS OKAY thats REALLY very good ID LIKE TO try it JUST one more time AND then well call it a day SINGS ‘I met her on a monday and my heart stood still CLASS SINGS ‘DA doo RUN RUN RUN da doo RUN RUN RUSS SINGS ‘SOMEBODY told me that her name was jill CLASS SINGS ‘DA doo RUN RUN RUN da doo RUN RUN RUSS okay great great ALL RIGHT ILL SEE YOU next week AND well learn some new tunes AND WELL HAVE A GREAT TIME bye bye CLASS bye bye

Closed-Captioning: hey move YOUR cab buddy HORNS HONKING you cant stop ** *** ****** ON A bridge CARS CRASHING OK thats ****** very good ** **** LETS try it **** one more time *** then well call it a day ***** I met her on a monday and my heart stood still ***** ***** DA doo RON RON RON da doo *** *** RON RON SOMEBODY told me that her name was jill ***** ***** DA doo RON RON RON da doo *** RON RON okay great great *** ***** *** *** *** next week *** well learn some new tunes *** **** **** * ***** **** bye bye ALL bye bye

Corresponding Extensible Markup Language (XML) representation of multi-track metadata coming from both script and closed-caption file for these two scenes follows. The scene description, the division into scenes, and the characters are derived from the script. Descriptors and caption are taken from the closed-caption file (along with timestamps modified as described below). Some external (non-aligned) metadata (title, year, release date, director, genre are included. Additionally, the characters from the script are augmented with actor information (from external metadata), if known. Finally, the timestamps from the closed caption are offset by a global offset to account for an initial Federal Bureau of Investigation (FBI) warning. That global offset also came from external metadata.

```
  <Scene t=“6”>
  <MovieMetadata>
  <Metadata><Key><![CDATA[Title]]></Key><Value><!
[CDATA[Stripes]]><Value></Metadata>
  <Metadata><Key><![CDATA[Year]]></Key><Value><!
[CDATA[1981]]><Value></Metadata>
  <Metadata><Key><![CDATA[ReleaseDate]]></Key><Value><!
[CDATA[6/26/1981]]><Value></Metadata>
  <Metadata><Key><![CDATA[Director]]></Key><Value><![CDATA[Ivan
Reitman]]><Value></Metadata>
  <Metadata><Key><![CDATA[Genre]]></Key><Value><!
[CDATA[Comedy]]><Value></Metadata>
  <Metadata><Key><![CDATA[Genre]]></Key><Value><!
[CDATA[War]]><Value></Metadata>
  </MovieMetadata>
  <SceneDescription><SceneLine><FullLine><!
[CDATA[EXTERIOR/BRIDGE]]></FullLine>
  <SceneLocation><![CDATA[EXTERIOR/BRIDGE]]></SceneLocation>
  </SceneLine>
  </SceneDescription>
  <CharactersFromScript>
  <Character><Raw><!
[CDATA[MOTORISTS]]></Raw><CharacterDescriptionString><![CDATA[MOTORISTS
(no details available)]]></CharacterDescriptionString></Character>
  </CharactersFromScript>
  <SceneStartTimeStamp offsetAdjustment=“−960.0”><!
[CDATA[06:20:07]]></SceneStartTimeStamp>
  <SceneEndTimeStamp offsetAdjustment=“−960.0”><!
[CDATA[06:32:05]]></SceneEndTimeStamp>
  <CCaption>
  <CCLineNumber><![CDATA[0081]]></CCLineNumber>
  <Timestamp><![CDATA[01:06:04:07 01:06:05:27]]></Timestamp>
  <Descriptor><![CDATA[(HORNS HONKING)]]></Descriptor>
  <CCLineNumber><![CDATA[0082]]></CCLineNumber>
  <Timestamp><![CDATA[01:06:07:12 01:06:09:08]]></Timestamp>
  <CCLineText><![CDATA[Hey, move your cab,]]></CCLineText>
  <CCLineText><![CDATA[buddy!]]></CCLineText>
  <CCLineNumber><![CDATA[0083]]></CCLineNumber>
  <Timestamp><![CDATA[01:06:10:00 01:06:11:10]]></Timestamp>
  <Descriptor><![CDATA[(HORNS HONKING)]]></Descriptor>
  <CCLineNumber><![CDATA[0084]]></CCLineNumber>
  <Timestamp><![CDATA[01:06:13:13 01:06:16:05]]></Timestamp>
  <CCLineText><![CDATA[You can't stop]]></CCLineText>
  <CCLineText><![CDATA[on a bridge!]]></CCLineText>
  </CCaption>
  </Scene>
  <Scene t=“7”>
  <MovieMetadata>
  <Metadata><Key><![CDATA[Title]]></Key><Value><!
[CDATA[Stripes]]><Value></Metadata>
  <Metadata><Key><![CDATA[Year]]></Key><Value><!
[CDATA[1981]]><Value></Metadata>
  <Metadata><Key><![CDATA[Release Date]]></Key><Value><!
[CDATA[6/26/1981]]><Value></Metadata>
  <Metadata><Key><![CDATA[Director]]></Key><Value><![CDATA[Ivan
Reitman]]><Value></Metadata>
  <Metadata><Key><![CDATA[Genre]]></Key><Value><!
[CDATA[Comedy]]><Value></Metadata>
  <Metadata><Key><![CDATA[Genre]]></Key><Value><!
[CDATA[War]]><Value></Metadata>
  </MovieMetadata>
  <SceneDescription><SceneLine><FullLine><!
[CDATA[INTERIOR/CLASSROOM]]></FullLine>
  <SceneLocation><![CDATA[INTERIOR/CLASSROOM]]></SceneLocation>
  </SceneLine>
  </SceneDescription>
  <CharactersFromScript>
  <Character><Raw><!
[CDATA[CLASS]]></Raw><CharacterDescriptionString><![CDATA[CLASS(no details
available)]]></CharacterDescriptionString></
  Character>
  <Character><Raw><![CDATA[RUSS]]></Raw><Normalized><!
[CDATA[Russell]]></Normalized><PlayedBy><![CDATA[Harold
Ramis]]></PlayedBy><CharacterDescriptionString><![CDATA[RUSS (Russell) played by
Harold Ramis]]></CharacterDescriptionString></Character>
  </CharactersFromScript>
  <CharactersFromCC>
  <Character><Raw><![CDATA[ALL]]></Raw><CharacterDescriptionString><!
[CDATA[ALL(no details available)]]></CharacterDescriptionString></Character>
  </CharactersFromCC>
  <SceneStartTimeStamp offsetAdjustment=“−960.0”><!
[CDATA[06:34:03]]></SceneStartTimeStamp>
  <SceneEndTimeStamp offsetAdjustment=“−960.0”><!
[CDATA[07:11:13]]></SceneEndTimeStamp>
  <CCaption>
  <CCLineNumber><![CDATA[0085]]></CCLineNumber>
  <Timestamp><![CDATA[01:06:18:03 01:06:19:12]]></Timestamp>
  <Descriptor><![CDATA[(CARS CRASHING)]]></Descriptor>
  <CCLineNumber><![CDATA[0086]]></CCLineNumber>
  <Timestamp><![CDATA[01:06:29:16 01:06:31:09]]></Timestamp>
  <CCLineText><![CDATA[Ok, that's very good.]]></CCLineText>
  <CCLineNumber><![CDATA[0087]]></CCLineNumber>
  <Timestamp><![CDATA[01:06:31:09 01:06:35:16]]></Timestamp>
  <CCLineText><![CDATA[Let's try it one more time.]]></CCLineText>
  <CCLineText><![CDATA[Then we'll call it a day.]]></CCLineText>
  <CCLineNumber><![CDATA[0088]]></CCLineNumber>
  <Timestamp><![CDATA[01:06:35:16 01:06:38:28]]></Timestamp>
  <CCLineText><![CDATA[. I met her on a Monday]]></CCLineText>
  <CCLineText><![CDATA[and my heart stood still .]]></CCLineText>
  <CCLineNumber><![CDATA[0089]]></CCLineNumber>
  <Timestamp><![CDATA[01:06:38:28 01:06:40:10]]></Timestamp>
  <CCLineText><![CDATA[. Da doo ron ron ron .]]></CCLineText>
  <CCLineNumber><![CDATA[0090]]></CCLineNumber>
  <Timestamp><![CDATA[01:06:40:10 01:06:42:18]]></Timestamp>
  <CCLineText><![CDATA[. Da doo ron ron .]]></CCLineText>
  <CCLineNumber><![CDATA[0091]]></CCLineNumber>
  <Timestamp><![CDATA[01:06:42:18 01:06:45:08]]></Timestamp>
  <CCLineText><![CDATA[. Somebody told me]]></CCLineText>
  <CCLineText><![CDATA[that her name was Jill .]]></CCLineText>
  <CCLineNumber><![CDATA[0092]]></CCLineNumber>
  <Timestamp><![CDATA[01:06:45:08 01:06:47:01]]></Timestamp>
  <CCLineText><![CDATA[. Da doo ron ron ron .]]></CCLineText>
  <CCLineNumber><![CDATA[0093]]></CCLineNumber>
  <Timestamp><![CDATA[01:06:47:01 01:06:48:22]]></Timestamp>
  <CCLineText><![CDATA[. Da doo ron ron ..]]></CCLineText>
  <CCLineNumber><![CDATA[0094]]></CCLineNumber>
  <Timestamp><![CDATA[01:06:48:22 01:06:50:18]]></Timestamp>
  <CCLineText><![CDATA[Okay, great, great!]]></CCLineText>
  <CCLineNumber><![CDATA[0095]]></CCLineNumber>
  <Timestamp><![CDATA[01:06:50:18 01:06:52:28]]></Timestamp>
  <CCLineText><![CDATA[Next week we'll]]></CCLineText>
  <CCLineText><![CDATA[learn some new tunes.]]></CCLineText>
  <CCLineNumber><![CDATA[0096]]></CCLineNumber>
  <Timestamp><![CDATA[01:06:52:28 01:06:54:03]]></Timestamp>
  <CCLineText><![CDATA[Bye-bye.]]></CCLineText>
  <CCLineNumber><![CDATA[0097]]></CCLineNumber>
  <Timestamp><![CDATA[01:06:54:03 01:06:55:13]]></Timestamp>
  <CCLineText><![CDATA[ALL: Bye-bye!]]></CCLineText>
  </CCaption>
  </Scene>
```

The description and the figures are of course exemplary, and the techniques may be implemented in many other fashions or employing any suitable component, and further may be applied to other applications, including other games. Other forms of implementations and other applications of the techniques are readily apparent and understood from the descriptions and figures.

For example, techniques of the present invention described above can process more difficult examples. For example, an example may include three metatdata sources, A, B and C. Source A might be a script while source B might be editorial comment on each scene. Souce C might be time-aligned metadata (e.g., closed-captioned, text-to-speech, human transcription, and so forth). In the case where source A and source B have more disparate text and are difficult to align, source A may have text that can be text aligned to source C and source B have text that be text aligned to source C. Techniques of the present invention can align metadata from source A to metadata from source C and generate timestamps into source A, while metadata can be aligned from source B to metadata from source C to generate timestamps into source B. Once complete, the metadata of source A, B and C can be merged on the timestamps.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback), and input from the user can be received in any form, including acoustic, speech, or tactile input.

The systems and techniques described here can be implemented in a computing system that includes a back-end component (e.g., a data server), or that includes a middleware component (e.g., an application server), or that includes a front-end component (e.g., a client computer having a graphical user interface or a web browser through which a user can interact with an implementation of the systems and techniques described here), or any combination of such back-end, middleware, or front-end components. The components of the system can be interconnected by any form or medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

The foregoing description does not represent an exhaustive list of all possible implementations consistent with this disclosure or of all possible variations of the implementations described. A number of implementations have been described. Nevertheless, it will be understood that various modifications may be made without departing from the spirit and scope of the systems, devices, methods and techniques described here. For example, various forms of the flows shown above may be used, with steps re-ordered, added, or removed. Accordingly, other implementations are within the scope of the following claims.

What is claimed is:

1. A method comprising:
receiving two or more variations of an underlying piece of content, each variation including metadata;
using a text alignment technique to correlate the metadata of the two or more variations; and
merging multiple sets of the metadata into one multi-track set from the correlation.

2-33. (canceled)
